(19) United States
(12) Patent Application Publication
(10) Pub. No.: US 2017/0129221 A1
(43) Pub. Date: May 11, 2017

(54) POLYOLEFIN BASED FILM WITH ENHANCED TWIST RETENTION PROPERTIES

(71) Applicants: Dow Global Technologies LLC, Midland, MI (US); PBBPOLISUR S.A., Buenos Aires (AR)

(72) Inventors: Nicholas C. Mazzola, Jundiai (BR); Maximiliano Zanetti, Bahia Blanca (AR); Eduardo Ruiz, Sugar Land, TX (US); Jorge C. Gomes, Sao Paulo (BR); Angels Domenech, Sao Paulo (BR)

(21) Appl. No.: 15/319,379

(22) PCT Filed: Jun. 3, 2015
(86) PCT No.: PCT/US2015/033932

§ 371 Date: Dec. 16, 2016

Related U.S. Application Data
(60) Provisional application No. 62/013,590, filed on Jun. 18, 2014.

(51) Int. Cl. B32B 27/08; B32B 27/32; B32B 7/02

(52) U.S. Cl. CPC B32B 27/08; B32B 7/02; B32B 27/32; B32B 2274/00; B32B 2307/744; B32B 2553/00

(57) ABSTRACT

A multilayer cast film including a. a first layer comprising a polyethylene having a density greater than 0.94 g/cm³ and a melt index less than or equal to 2 g/10min; b. a second layer comprising a polyethylene having a coefficient of friction (COF) greater than 0.5 and a Cling Force greater than 20 grams; wherein the second layer is an external layer of the film is provided.

### FIELD OF THE INVENTION

This invention relates to films and more particularly to films having enhanced twist retention properties.

### BACKGROUND

Twist wrap films are generally based on stiff materials such as polystyrene (PS), biaxially oriented polypropylene (BOPP), cast polypropylene (cPP) and polyethylene terephthalate (PET). These materials typically present with dead fold characteristics or poor elastic properties. Methods to measure dead fold are not clearly defined and generally the performance of different films are based on practical tests in packaging machines.

The use of high molecular weight polyethylene materials resins in film extrusion processes has recently been considered for such applications, mainly looking at the different film properties such films can provide. Extrusion process features are known in the art (see, for example, Billham, M.; Clarke, A. H.; Garrett, G.; McNally, G. M.; Murphy, W. R., The Effect of Extrusion Processing Conditions on the Properties of Blown and Cast Polyolefin Packaging Films, Dev. Chem. Eng. Mineral Process 1, pp. 137-146, 2003; or Giles, H. F. Jr.; Wagner, J. R. Jr.; Mount, E. Extrusion—The Definitive Processing Guide and Handbook, William Andrew Publishing/Plastics Design Library, 2005).

Polyethylene can be divided into high-density (HDPE, density 0.94 g/cm³ or higher), medium-density (MDPE density from 0.926 to 0.940 g/cm³), and low-density (LDPE, density from 0.910 to 0.925 g/cm³). See ASTM D4976-98: Standard Specification for Polyethylene Plastic Molding and Extrusion Materials. The use of HDPE type of materials for stretch films applications is very limited, as these materials have low toughness and tend to easily split once stretched. HDPE films are used when stiffness is the main requirement of the final application and the stiffness can be increased through film orientation after the extrusion.

HDPE-based films, however, typically do not exhibit sufficient cling force and twist retention to be used in twist wrap film applications. Accordingly, there is still the need for polyethylene films having the combination of high stiffness and twist retention properties.

### DETAILED DESCRIPTION

The term “polymer”, as used herein, refers to a polymeric compound prepared by polymerizing monomers, whether of the same or a different type. The generic term polymer thus embraces the term “homopolymer”, usually employed to refer to polymers prepared from only one type of monomer as well as “copolymer” which refers to polymers prepared from two or more different monomers.

“Polyethylene” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single site catalyzed Linear Low Density Polyethylene, including both linear and substantially linear low density resins (m-LLDPE); and High Density Polyethylene (HDPE). These polyethylene materials are generally known in the art; however the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, herein incorporated by reference). LDPE resins typically have a density in the range of 0.916 to 0.940 g/cm³.

The term “LLDPE”, includes both resin made using the traditional Ziegler-Natta catalyst systems as well as single-site catalysts such as metallocenes (sometimes referred to as “m-LLDPE”). LLDPEs contain less long chain branching than LDPEs and includes the substantially linear ethylene polymers which are further defined in U.S. Pat. No.5,272,236, U.S. Pat. No.5,278,272, U.S. Pat. No.5,582,923 and U.S. Pat. No.5,733,155; the homogeneously branched linear ethylene polymer compositions such as those in U.S. Pat. No.3,645,992; the heterogeneously branched ethylene polymers such as those prepared according to the process disclosed in U.S. Pat. No. 4,076,698; and/or blends thereof (such as those disclosed in U.S. Pat. No.3,914,342 or U.S. Pat. No.5,854,045). The Linear PE can be made via gas-phase, solution-phase or slurry polymerization or any combination thereof, using any type of reactor or reactor configuration known in the art, with gas and solution phase reactors being most preferred.

The term “HDPE” refers to polyethylenes having densities greater than about 0.940 g/cm3, which are generally prepared with Ziegler-Natta catalysts, chrome catalysts or even metallocene catalysts.

The following analytical methods are used in the present invention:
Density is determined in accordance with ASTM D792.
“Melt index” also referred to as “I₂” is determined according to ASTM D1238 (190° C., 2.16 kg).
2% Secant Modulus is determined according to ASTM D882.
Elmendorf Tear is determined according to ASTM D-1922.
Gloss is determined at a 45° angle according to ASTM D-2457.
Haze of the resulting film refers to the total haze (that is internal haze plus external haze) and is determined according to ASTM D1003.
Clarity is determined according to ASTM D1746.
Coefficient of friction (COF) is measured according to D1894.
Cling Force is measured according to D5458.

Films

In its broadest sense the present invention is a film comprising at least the following layers:
a. a first layer comprising a polyethylene having a density greater than 0.94 g/cm³ and a melt index less than or equal to 2 g/10min;
b. a second layer comprising a polyethylene having a coefficient of friction (COF) greater than 0.5 and a Cling Force greater than 20 grams;
wherein the second layer is an external layer of the film.

In another embodiment, the multilayer cast film further comprises a third layer which is a second external layer which comprises a polyolefin, and which has a coefficient of friction less than 0.5 and a cling force of less than 20 grams.

The first layer (which is an inner or core layer when there are at least two exterior layers) will generally comprise from 30 to 90 percent by weight of the film, more preferably from 40 to 70 percent by weight of the cast film. The second layer will generally comprise from 10 to 70 percent by weight of the cast film more preferably from 30 to 60 percent by weight of the cast film. It is generally preferred that the third layer, when present be approximately the same thickness as the second layer, and hence when present it is generally preferred that the third layer and second layer each comprise from 5 to 40 percent by weight of the cast film more preferably from 10 to 30 percent by weight of the cast film. It is also contemplated that the cast film may comprise additional layers. These layers may be selected to provide additional functionality, for example barrier properties or seal ability.

The first layer of the films of the present invention will comprise a High Density Polyethylene polymer (HDPE). HDPE materials are well known in the art, and in general refer to linear polyethylene materials having a density of at least 0.94 g/cm³. Any type of HDPE can be used in the present invention. This includes the substantially linear ethylene polymers which are further defined in U.S. Pat. No. 5,272,236, U.S. Pat. No. 5,278,272, U.S. Pat. No. 5,582,923 and U.S. Pat. No. 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The HDPE can be made via gas-phase, solution-phase or slurry polymerization or any combination thereof, using any type of reactor or reactor configuration known in the art, with gas and slurry phase reactors being most preferred. Preferred HDPE resins are sold by The Dow Chemical Company under the trade name DOWLEX™ 2050B and ELITE™ 5960G for example.

The HDPE component for use in the first layer (an internal layer in a structure with at least 3 layers) has a density of at least 0.940 g/cm³. All individual values and subranges from at least 0.940 g/cm³ are included and disclosed herein. For example, the lower limit of the HDPE density can be 0.940, 0.942, 0.95 or 0.955 g/ cm³. In a particular embodiment, the HDPE has a density equal to or less than 0.969 g/ cm³ All individual values and subranges from equal to or less than 0.969 g/ cm³ are included and disclosed herein; for example, the upper limit of the HDPE density can be 0.969, 0.958, 0.949 g/ cm³. The HDPE component for use in the first layer also has a melt index, I₂, less than 2 g/10 min. All individual values and subranges from less than 2 g/10 min are included and disclosed herein. For example, the HDPE I₂ can be less than 2, 1.7, 1.3 or 1.0 g/10min. In a particular embodiment, the HDPE I₂ is greater than or equal to 0.01 g/10min. All individual values and subranges greater than or equal to 0.01 g/10 min are included and disclosed herein. For example, the HDPE I₂ lower limit can be 0.01, 0.05, 0.1, 0.5, or 1 g/10min.

The first layer preferably contains from about 50 to 100% of one or more HDPE meeting the density and melt index limitations, but may also contain other materials. Thus the total composition for use in the first layer may advantageously comprise from 75 to 98% HDPE or from 85 to 90% HDPE. One polymer which may advantageously be added to the core layer in a minor amount is a high pressure low density type resin known in the industry as Low Density Polyethylene or LDPE. LDPE having a density in the range of 0.917 to 0.935 g/cm³, preferably 0.920 to 0.929 g/cm³ are preferred. It is also preferred that the LDPE have a melt index of from 0.1 to 5.0 g/10 min, more preferably from 0.3 to 2.0 g/10 min. While the first layer of the present invention may contain as much as 50 percent by weight LDPE, it is preferred that the first layer comprise from 2-20 percent LDPE, more preferably from 5 to 15% LDPE.

In a particular embodiment, the first layer may contain less than 50 wt % HDPE having an I₂ greater than or equal to 2 g/10 min. All individual values and subranges less than 50 wt % are included and disclosed herein. For example, the amount of HDPE having an I₂ greater than or equal to 2 g/10 min in the first layer can be less than 50 wt %, or in the alternative, less than 45 wt %, or in the alternative, less than 40 wt %, or in the alternative, less than 35 wt %.

In another embodiment, the first may contain less than 50 wt % of an LDPE. All individual values and subranges less than 50 wt % are included and disclosed herein. For example, the amount of LDPE in the first layer can be less than 50 wt %, or in the alternative, less than 45 wt %, or in the alternative, less than 40 wt %, or in the alternative, less than 35 wt %.

In a particular embodiment, the second and/or third layers comprise from 0.1 to 100 wt % one or more cling resins. Cling resins used herein include polyethylene plastomers and elastomers, polypropylene plastomers and elastomers, ultralow density polyethylene, very low density polyethylene and polyisobutlyene.

In a particular embodiment, the cling resin is one or more polyethylene plastomers and/or elastomer, wherein the cling resin is present in an amount from 0.1 to 50 wt %. All individual values and subranges from 0.1 to 50 wt % are included and disclosed herein; for example, the amount of one or more polyethylene plastomers and/or elastomers can be from a lower limit of 0.1, 10, 25, 37, or 45 wt % to an upper limit of 1, 15, 28, 40 or 50 wt %.

In a particular embodiment, the cling resin is one or more polypropylene plastomers and/or elastomers, wherein the cling resin is present in an amount from 0.1 to 50 wt %. All individual values and subranges from 0.1 to 50 wt % are included and disclosed herein; for example, the amount of one or more polypropylene plastomers and/or elastomers can be from a lower limit of 0.1, 5, 15, 20, 35, or 45 wt % to an upper limit of 1, 10, 17, 27, 45 or 50 wt %.

In a particular embodiment, the cling resin is one or more ultralow density polyethylene, wherein the cling resin is present in an amount from 20 to 100 wt %. All individual values and subranges from 20 to 100 wt % are included and disclosed herein; for example, the amount of one or more ultralow density polyethylene can be from a lower limit of 20, 35, 50, 65, 80 or 99 wt % to an upper limit of 25, 40, 55, 70, 85 or 100 wt %.

In a particular embodiment, the cling resin is one or more very low density polyethylene, wherein the cling resin is present in an amount from 20 to 100 wt %. All individual values and subranges from 20 to 100 wt % are included and disclosed herein; for example, the amount of one or more very low density polyethylene can be from a lower limit of 20, 35, 50, 65, 80 or 99 wt % to an upper limit of 25, 40, 55, 70, 85 or 100 wt %.

In a particular embodiment, the cling resin is polyisobutylene, wherein the cling resin is present in an amount from 0.1 to 10 wt %. All individual values and subranges from 0.1 to 10 wt % are included and disclosed herein; for example, the amount of polyisobutylene can be from a lower limit of 0.1, 1, 3, 5, 7 or 9 wt % to an upper limit of 0.5, 2, 4, 6, 8 or 10 wt %.

The second layer of the film comprises a polyethylene having a coefficient of friction (COF) greater than 0.5 and a Cling Force of greater than 20 grams. Coefficients of friction greater than 1 are difficult to measure. All individual values and subranges of COF greater than 0.5 are included and disclosed herein; for example, the COF can be greater than 0.5, or in the alternative, greater than 0.55, or in the alternative, greater than 0.6, or in the alternative, greater than 0.65, or in the alternative, greater than 0.7, or in the alternative, greater than 0.75. All individual values and subranges of cling force greater than 20 grams are included and disclosed herein. For example, the cling force can be greater than 20 grams, or in the alternative, greater than 50 grams, or in the alternative, greater than 120 grams, or in the alternative, greater than 160 grams, or in the alternative, greater than 200 grams, or in the alternative, greater than 270 grams, or in the alternative, greater than 300 grams, or in the alternative, greater than 320 grams. In a particular embodiment, the cling force is less than or equal to 450 grams. All individual values and subranges from less than or equal to 450 grams are included and disclosed herein; for example, the cling force can be from an upper limit of 450 grams, or in the alternative, the cling force can be from an upper limit of 350 grams, or in the alternative, the cling force can be from an upper limit of 250 grams, or in the alternative, the cling force can be from an upper limit of 150 grams.

The polyethylene of the second layer may comprise LLDPE. When used, the LLDPE component for use in the second and/or third layers (the external layers) has a density of at least 0.900 g/cm³. The LLDPE component for use in the second or third layers also has a melt index greater than 2.0 g/10 min, more preferably greater than 3.0 g/10 min and lower than 10 g/10min.

In a particular embodiment, the film comprises a third layer which is a second external layer. When a third layer is present, the second and third layers are external layers and the first layer is a core layer.

The second layer preferably contains from about 80 to 100% of one or more LLDPE resins meeting the density and melt index limitations, but may also contain other materials. Thus the total composition for use in the first layer may advantageously comprise from 75 to 98% HDPE or from 85 to 90% HDPE. It is preferred that the LLDPE resin of the second and third layers be the LLDPE described herein. The second layer may be 100% LLDPE in those instances in which a third (external) layer is present wherein the third (external) layer includes a cling resin. That is, only one of the external layers need include a cling resin component. Alternatively, when the second (external) layer comprises a cling resin, the third (external) layer, when present, may be 100 wt % LLDPE.

The second and/or third layers (i.e., the external layers) have a coefficient of friction (COF) greater than 0.5. All individual values and subranges from greater than 0.5 are included and disclosed herein. For example, the COF can be greater than 0.5, or in the alternative, greater than 0.75, or in the alternative, greater than 1.0.

The second and/or third layers (i.e., the external layers) have a Cling Force greater than 20 grams. All individual values and subranges from greater than 20 grams are included and disclosed herein. For example, the Cling Force can be greater than 20 grams, or in the alternative, greater than 50 grams, or in the alternative, greater than 100 grams.

In a particular embodiment, the film has a total thickness of less than or equal to 80 microns. All individual values and subranges from an upper limit of 80 microns are included and disclosed herein; for example, the film thickness can have an upper limit of 80, 70, 60, 50, 40 or 30 microns.

In a particular embodiment, the films of the present invention can be made by conventional extrusion film methods as is generally known in the art. While not necessary for practice of the present invention, it is possible to subject the films to post-extrusion mono- or biaxial orientation. In some embodiments the films of the present invention may be advantageously stretched at least 50%, preferably at least 100% in the machine and/or cross directions.

As is generally known in the art, each of the layers may include additives, such as pigments, inorganic fillers, UV stabilizers, antioxidants, and slip or antiblock additives.

### EXAMPLES

In order to demonstrate the effectiveness of the present invention a series of 3 layer cast films were made.

Films were produced using 3 different grades of linear polyethylene (3 HDPE—Resin 1, 2, and 3). The HDPE materials used in this study were characterized in order to quantify differences on molecular weight averages and distribution, rheology behavior and densities. Values are described in Table 1.

TABLE 1

| | I₂ @ 190° C. | | |
|---|---|---|---|
| | and 2.16 kg | | Density |
| | (g/10 min) | I₁₀/I₂ | (g/cm³) |
| Resin 1 | 4.01 | 7.4 | 0.9425 |
| Resin 2 | 0.90 | 10.0 | 0.9636 |
| Resin 3 | 1.05 | 7.8 | 0.9536 |

Table 2 provides the film structures of the Inventive and Comparative Examples. Each exterior layer is 25% of the thickness of the total film thickness and the core layer thickness represents 50% of the total film thickness.

TABLE 2

| | Film Structures | | | |
|---|---|---|---|---|
| | Second | First | Third | Total |
| | Layer | Layer | Layer | Film |
| | (Exterior) | (Core) | (Exterior) | Thickness |
| | (25%) | (50%) | (25%) | (μm) |
| Comp. Ex. 1a | 100% Resin 1 | 100% Resin 1 | 100% Resin 1 | 12 |
| Comp. Ex. 1b | | | | 17 |
| Comp. Ex. 1c | | | | 23 |
| Comp. Ex. 2 | 100% Resin 3 | 100% Resin 3 | 100% Resin 3 | 23 |
| Inv. Ex. 1a | 100% Resin 1 | 100% Resin 2 | 100% Resin 1 | 17 |
| Inv. Ex. 1b | | | | 23 |
| Inv. Ex. 2a | 100% Resin 1 | 100% Resin 3 | 100% Resin 1 | 12 |
| Inv. Ex. 2b | | | | 17 |
| Inv. Ex. 2c | | | | 23 |

The films were produced using a Collin cast line and fabrication conditions are described in Table 3.

TABLE 3

| Film | Die | Set | | Chill | Winding |
|---|---|---|---|---|---|
| Thickness | gap | Tm | Output | Temp | Speed |
| (μm) | (mm) | (° C.) | (kg/h) | (° C.) | (m/min) |
| 12 | 0.7 | 235 | 6 | 6 | 29.0 |
| 17 | 0.7 | 235 | 6 | 6 | 23.0 |
| 23 | 0.7 | 235 | 6 | 6 | 16.0 |

Films properties of the Inventive and Comparative Examples are presented in Table 4. Inventive examples demonstrate the films with high modulus could be obtained by using HDPE resins (density >0.940 g/cm³) with high molecular weight (I_{2<2} g/10min).

TABLE 4

| | Total | | | | | Sec. | Sec. |
|---|---|---|---|---|---|---|---|
| | Film | | | | Tear | Mod. | Mod. |
| | Thickness | | Gloss | | MD | 2% MD | 2% CD |
| | (μm) | Haze | 45° | Clarity | (g) | (MPa) | (MPa) |
| Comp. | 12 | 3.42 | 2.4 | 99.6 | 19.2 | 54 | 474 |
| Ex. 1a | | | | | | | |
| Comp. | 17 | 4.39 | 4.8 | 99.7 | 22.6 | 43 | 597 |
| Ex. 1b | | | | | | | |
| Comp. | 23 | 5.42 | 8.1 | 99.6 | 28.1 | 81 | 489 |
| Ex. 1c | | | | | | | |
| Comp. | 23 | 7.33 | 5.6 | 99.3 | 32 | 05 | 895 |
| Ex. 2 | | | | | | | |
| Inv. | 17 | 6.86 | 2.5 | 98.7 | 30 | 24 | 691 |
| Ex. 1a | | | | | | | |
| Inv. | 23 | 8.03 | 1.4 | 98.8 | 22.3 | 45 | 646 |
| Ex. 1b | | | | | | | |
| Inv. | 12 | 3.15 | 4.4 | 99.5 | 9.6 | 72 | 700 |
| Ex. 2a | | | | | | | |
| Inv. | 17 | 3.96 | 5.6 | 99.4 | 13.6 | 93 | 587 |
| Ex. 2b | | | | | | | |
| Inv. | 23 | 4.89 | 0.6 | 99.6 | 21.6 | 80 | 579 |
| Ex. 2c | | | | | | | |

Different cling resins and cling resin levels in one external layer were evaluated to examine the impact of such variable on the twist retention properties. Table 5 lists the external layer components evaluated.

TABLE 5

| | | I2 @ 190° C. | |
|---|---|---|---|
| | | 2.16 kg | Density |
| | Type | (g/10 min) | (g/cm3) |
| Resin 1 | HDPE | 4.01 | 0.9425 |
| Resin 4 | ULDPE | 4.0 | 0.904 |
| Resin 5 | PP based | 8.0* | 0.865 |
| | Elastomer | | |
| Resin 6 | LLDPE | 2.3 | 0.917 |
| Resin 7 | PE based | 3.0 | 0.875 |
| | Elastomer | | |

*Melt Flow Rate, @230 deg C./2.16 kg

The cling results for different resins and COF are described in Table 6. Cling values were measured at 250% stretch level in a Highlight machine. Core layers were based on resin 2.

TABLE 6

| | | | COF |
|---|---|---|---|
| | Modified | | (modified |
| | external | Cling @ | surface vs |
| | layer | 250% | modified |
| | composition | (g) | surface) |
| Comparative Example 1 | 100% Resin 1 | 0 | 0.3 |
| Inventive Example 3 | 100% Resin 4 | 101 | Not measurable* |
| Inventive Example 4 | 60% Resin 4 + | 57 | Not measurable* |
| | 40% Resin 6 | | |
| Inventive Example 5 | 40% Resin 4 + | 45 | Not measurable* |
| | 60% Resin 6 | | |
| Inventive Example 6 | 10% Resin 5 + | 41 | Not measurable* |
| | 90% Resin 6 | | |
| Inventive Example 7 | 100% Resin 6 | 22 | 0.8 |
| Inventive Example 8 | 100% Resin 7 | 333 | Not measurable* |

*Not measureable indicates that the coefficient of friction is greater than 1.

Comparative Example 1 and Inventive Examples 6 and 7 were tested for twist retention. The tests were performed in a candy wrap machine using the modified surface as internal or external surface, always with just one surface modified. The results indicated that Comparative Example 1 did not have enough dead fold or cling force to retain twisted form. Inventive Examples 4-8 passed application requirements and final twisted form was retained after the packaging process. Inventive Example 6 demonstrated better retention than Inventive Example 7, indicating that higher cling forces are better for twist wrap retention.

As used herein, the term “dead fold characteristics” means the ability of the polymeric film to retain its shape permanently once it is folded or wrapped about a food item or container and not spring back to an unfolded state. As an example, aluminum foil, once folded or shaped about an item, retains that shape and, thus, may be considered to have excellent dead fold characteristics. Conversely, typical plastic food wraps tend to quickly spring back, unfold, or unwrap after being shaped about an item. This is an example of poor dead fold characteristics.

What is claimed is:

1. A multilayer cast film comprising:
a. a first layer comprising a polyethylene having a density greater than 0.94 g/cm³ and a melt index less than or equal to 2 g/10min;
b. a second layer comprising a polyolefin having a coefficient of friction (COF) greater than 0.5 and a Cling Force greater than 20 grams;
wherein the second layer is a first external layer of the film.

2. The multilayer cast film of claim 1 further comprising a third layer which is a second external layer which comprises a polyolefin, and which has a coefficient of friction less than 0.5 and a cling force of less than 20 grams.

3. The multilayer cast film of claim 1 wherein the film comprises at least 3 layers and wherein each external layer independently comprises a polyethylene having a density greater than 0.900 g/cm³ and a melt index, I₂, greater than or equal to 2.0 g/10 min.

4. The multilayer cast film of claim 1 wherein the first layer comprises a linear polyethylene having a density greater than 0.95 g/cm³.

5. The multilayer cast film of claim 1 wherein the first layer comprises a linear polyethylene having a melt index, I₂, less than or equal to 1.0 g/10min.

6. The multilayer cast film of claim 1 wherein the second layer comprises a linear polyethylene having a melt index, I₂, greater than or equal to 2.0 g/10min.

7. The multilayer cast film of claim 1 further comprising one or more additional polymers in the first layer, wherein the one or more additional polymers is less than 50% by weight of the first layer.

8. The multilayer cast film of claim 7 wherein the one or more additional polymers is a low density polyethylene.

9. The multilayer cast film of claim 1 wherein said film has a total thickness of less than or equal to 80 microns.

10. The multilayer cast film of claim 1 wherein the second layer comprises a resin selected from the group consisting of polyethylene plastomers, polyethylene elastomers, polypropylene plastomers, polypropylene elastomers, ultralow density polyethylene, very low density polyethylene and polyisobutlyene.
